(19) United States
(12) Patent Application Publication
(10) Pub. No.: US 2007/0097139 A1
(43) Pub. Date: May 3, 2007

(54) Method and apparatus of primitive filter in graphic process applications

(76) Inventors: Chao-Chin Chen, Hsinchu City (TW); Chih-Hung Wu, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/263,938

(22) Filed: Nov. 2, 2005

(51) Int. Cl. G09G 5/00

(52) U.S. Cl. 345/581

(57) ABSTRACT

This invention discloses an apparatus and a method for a primitive filter. The primitive filter apparatus is used in graphic process and is applied in Graphic Process Unit. The primitive filter apparatus at least comprises a storage unit and a filter unit. The storage unit stores a plurality of input primitives. The filter unit couples to the storage unit and processes the stored of the plurality of input primitives, the function of the filter unit 32 is to drop or select the stored of the plurality of input primitives based on at least one predetermination. The storage unit further comprises a controller and a data buffer. The filter unit comprises an arithmetic logic unit and a determination unit. The at least one predetermination is a condition: the primitive filter apparatus drops the stored of the plurality of input primitives if does not cover any pixels. The primitive filtering method comprises the step of: providing a stored of a plurality of input primitives into the primitive filter apparatus for dropping or selecting based on at least one predetermination, dropping the stored of the plurality of input primitives from the primitive filter apparatus if the at least one predetermination is not met or selecting the plurality of input primitives from the primitive filter apparatus if the at least one predetermination is met.

### FIELD OF THE INVENTION

The present invention generally relates to an apparatus and a method for primitive filter, and more particularly to a filter unit in graphic process systems for dropping or selecting a stored of a plurality of input primitives based on at least one predetermination.

### BACKGROUND OF THE INVENTION

In conventional graphics process applications, especially in animations, all of scenes shown on a screen, or other display devices are basically composed of objects through sampling, interconnection and rendering. In other words, these objects refer to as primitives; for example, basic primitive can be a triangle, or other polygons. As illustrated in FIG. 1, a conventional graphic process architecture for a three-dimensional pipeline. A vertex shader 11 is used for replacing fixed-function Transformation and Lighting (T&L) pipeline for 3D objects, including vertex morphing, particle system rendering, or texture generation. These 3D objects carry much information that receives a plurality of input data, such as, for example, object shape data in object space, color, texture information, luminance information, and so forth. After processed by the vertex shader 11, the output data represents the object with texture and other properties that are transferred to a primitive set unit 12 to build primitives. These primitives are usually formed by the interconnection of individual pixels and corresponding locations are shown in FIG. 2 that will be illustrated next. Those primitives are then sent to a rasteriztion unit 13. The rasterization unit 13 will first set up the 3D primitives such as points, lines or polygons by composing vertices. The 3D primitives will be raterized to generate pixels among the primitives. The attributes such as diffuse color, texture coordinate, or position of each pixel will be generated in the rasterization unit 13 by interpolating the attributes of each vertices. The output of the rasterization unit 13 is then sent to a pixel shader 14 for further rendering, such as hidden surface removal, text mapping, and so forth. After processed by the pixel shader, those output of each pixel could be displayed on screen for people watching. However, one disadvantage must be resolved, as illustrated in FIG. 2, primitives on a pixel grid coordinate system shows the location of triangle primitives that includes triangle primitives which cover pixels 21 and without covering pixels 22 that are processed by computation powers. Consequently, the loading for computation power often increases that wastes resources and causes low efficiency. Thus, there is a need to improve graphic process applications by employing a primitive filter apparatus and method for resources saving and increasing computationally efficiency.

### SUMMARY OF THE INVENTION

Briefly stated, the present invention is directed to a primitive filter apparatus that employs a filter unit that is capable of performing dropping a plurality of input primitives based on at least one predetermination for resource saving and computationally efficient manner in graphic process, so as to accelerating vertex processing. In an exemplary embodiment, a primitive filter apparatus according to the present invention includes a storage unit for storing a plurality of input primitives; and a filter unit, coupled to the storage unit, operative to process the stored of the plurality of input primitives, the filter unit including means for dropping or selecting the stored of the plurality of input primitives based on at least one predetermination.

The primitive filter apparatus can be set between a vertex shader and a primitive setup unit and is applied in Graphic Process Unit. The storage unit includes a data buffer that temporarily stores a plurality of input primitives with associated data that enabling the filter unit to select the stored of the plurality of input primitives and a controller that controls the transfer of the stored of the plurality of input primitives with associated data from the vertex shader. The associated data are primitive parameters; the primitive parameters include object shape data in object space, color, texture information, viewing angle information, lighting information, and so forth. The primitive types can be point, line, polygon, circle or circular disk. The associated data for the point includes position and/or point size. The associated data for the line includes position of two end points, lengths, slope and position of line center. The associated data for the polygon includes position of vertices. The associated data for the circle includes position of center and radius and position of two end points on a diameter. The associated data for circular disk includes position of center and position of two end points on a diameter.

The filter unit includes an arithmetic logic unit (ALU) for executing arithmetic and logic calculations and a determination unit that performs determination mode according to calculation results, the calculation results are provided by the ALU. The at least one predetermination is a condition that is set: the primitive filter apparatus 30 drops the stored of the plurality of input primitives if does not cover any pixels. The pixel is an integer-value that corresponds to a pixel grid coordinate system. The determination unit will produce a discard signal to request to drop the stored of the plurality of input primitives if does not cover any pixels otherwise the stored of the plurality of input primitives which covers pixels that will be selected for sending to a primitive setup unit. By employing the filter unit of the present invention, the associated primitive filter apparatus is more resource saving than conventional graphic process because computation power can be used only on the stored of the plurality of input primitives that covers pixels and efficiency is also improved.

In addition, according to the present invention, a method of primitives dropping in a primitive filter apparatus is provided. The method at least comprises the steps of: providing a stored of a plurality of input primitives for dropping or selecting based on at least one predetermination, and dropping the stored of the plurality of input primitives if the at least one predetermination is not met, or selecting the stored the plurality of input primitives if the at least one predetermination is met.

### BRIEF DESCRIPTION OF THE DRAWINGS

These and other objects and features of the present invention will become clear from the following description of the preferred embodiments given with reference to the attached drawings, in which:

FIG. 1 is a 3D graphic pipeline;

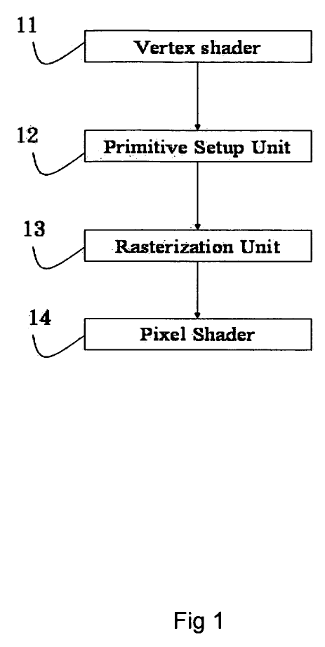

FIG. 2 is an example of triangle primitives on pixel grid coordinate system;

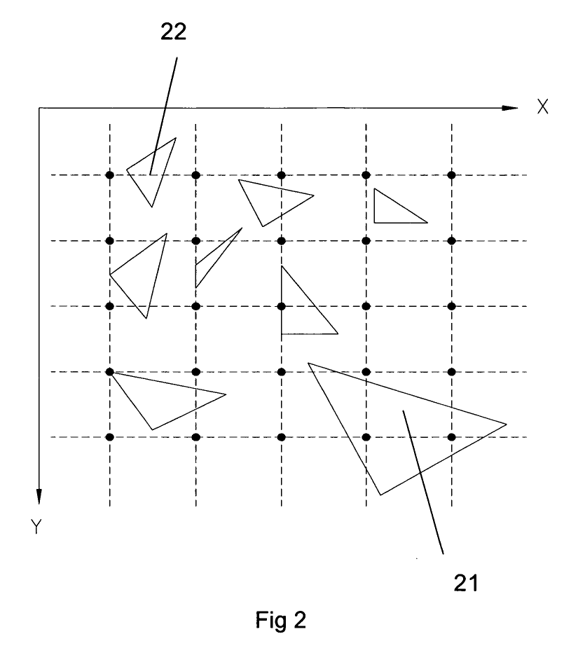

FIG. 3 is a block diagram of the primitive filter apparatus according to an embodiment of present invention;

FIG. 4 is a detail block diagram of the a primitive filter apparatus according to an embodiment of present invention;

FIG. 5 shows a result regarding triangle primitives on a pixel grid coordinate system when using a primitive filter apparatus;

FIG. 6 shows a result regarding circle primitives on a pixel grid coordinate system when using a primitive filter apparatus;

FIG. 7 is a general flowchart of an example of a primitive filtering method according to an embodiment of the present invention; and

FIG. 8 is a detail flowchart of an example of a primitive filtering method according an embodiment of the present invention.

### DETAILED DESCRIPTION OF THE PREFERRED EMBODIMENTS

To make it easier for our examiner to understand the objective of the invention, its innovative features and performance, a detailed description and technical characteristics of the present invention are described together with the drawings as follows.

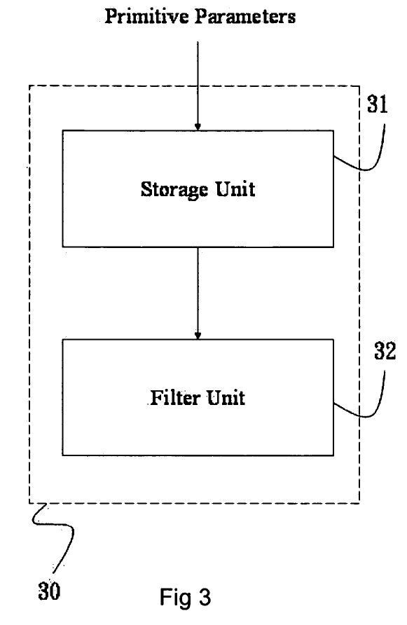

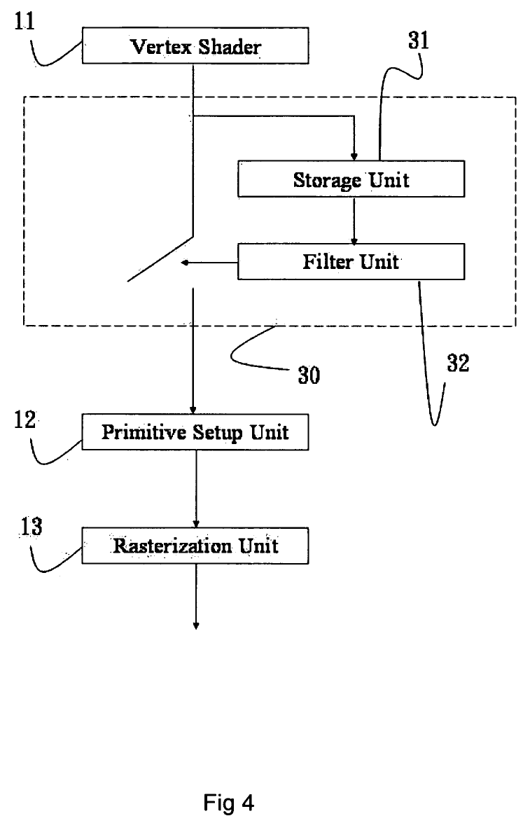

Referring to FIG. 3 and FIG. 4, two block diagrams of examples of a primitive filter apparatus according to an embodiment of the present invention are illustrated. The primitive filter apparatus 30 is applied in Graphic Process Unit. As shown in FIG. 3, the primitive filter apparatus 30 includes a storage unit 31 and a filter unit 32. The storage unit 31 for storing a plurality of input primitives and the filter unit 32 couples to the storage unit 31 that processes the stored of the plurality of input primitives, the function of the filter unit 32 is to drop or select the stored of the plurality of input primitives based on at least one predetermination. More detail operations will be illustrated in FIG. 4 next.

Referring to FIG. 4, in an exemplary embodiment, the primitive filter apparatus 30 is set into a conventional pipeline architecture. The primitive filter apparatus 30 can be set between a vertex shader 11 and a primitive setup unit 12. After processed by the vertex shader 11, the output data represents the object with texture and other properties that must be transferring to the primitive filter unit 30 for further filtering. The storage unit 31 further comprises a data buffer that temporarily stores a plurality of input primitives with associated data that enabling the filter unit 32 to select the stored of the plurality of input primitives and a controller that controls the transfer of the stored of the plurality of input primitives with associated data from the vertex shader 11. The associated data are primitive parameters; the primitive parameters include object shape data in object space, color, texture information, viewing angle information, lighting information, and so forth. The primitive types can be point, line, polygon, circle or circular disk. The associated data for the point includes position and/or point size. The associated data for the line includes position of two end points, lengths, slope and position of line center. The associated data for the polygon includes position of vertices. The associated data for the circle includes position of center and radius and position of two end points on a diameter. The associated data for circular disk includes position of center and position of two end points on a diameter.

The filter unit 32 receives the stored of the plurality of input primitives with associated data from the storage unit 32 for performing filter calculations. The filter unit 32 includes an arithmetic logic unit (ALU) for executing arithmetic and logic calculations and a determination unit that performs determination mode according to calculation results, the calculation results are provided by the ALU. The at least one predetermination is a condition as illustrated in FIG. 3 that is set: the primitive filter apparatus 30 drops the stored of the plurality of input primitives if does not cover any pixels. The pixel is an integer-value that corresponds to a pixel grid coordinate system. The determination unit that produces a discard signal that implements the drop decision. The stored of the plurality of input primitives, which have covered pixels, that will be selected for sending to the primitive setup unit 12 that increases computationally efficiency. These outputs are then sent to the rasterization unit 13 to generate pixels among these primitives.

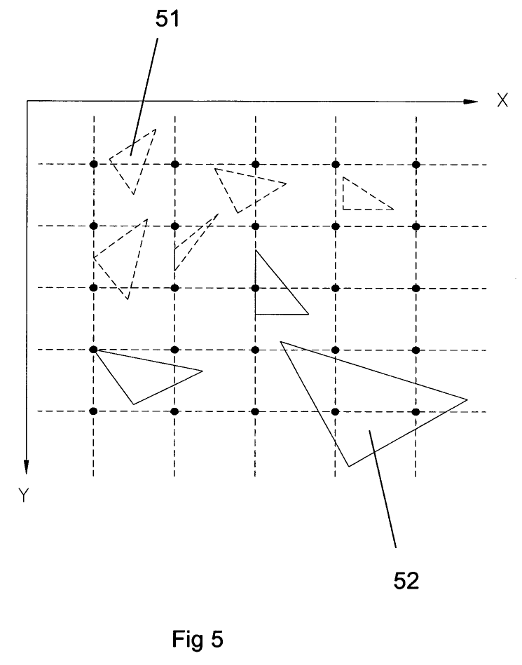

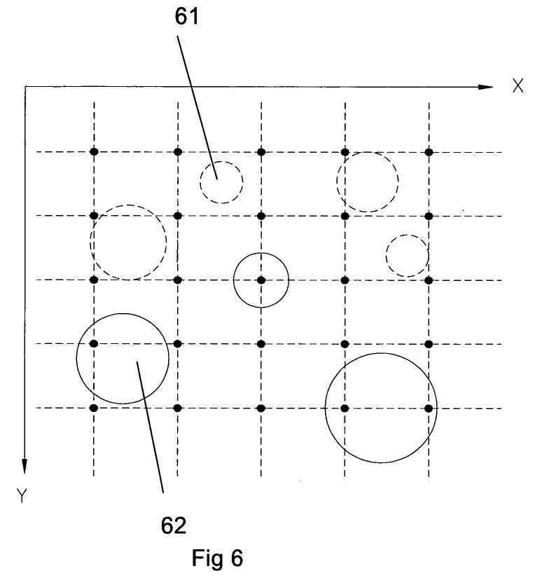

Referring to FIG. 5 and FIG. 6, two exemplary examples illustrate two results regarding primitive types on a pixel grid system when using a primitive filter apparatus. As shown in FIG. 5, triangles are such a primitive type that locates on a pixel grid coordinate system. The ALU of the filter unit executes arithmetic and logic calculations. Then the determination unit of the filter unit determines whether these triangles cover no pixels according to calculation results. If yes, these triangles with dotted line 51 will be dropped otherwise, these triangles with solid line 52 will be selected for sending to a primitive setup unit.

As shown in FIG. 6, circles are another primitive type that locates on a pixel grid coordinate system. The procedure is described as same as FIG. 5, the determination unit of the filter unit determines whether these circles cover no pixels. If yes, these circles with dotted line 61 will be dropped otherwise, these circles with solid line 62 will be selected. Circle parameters are position of center and radius and position of two end points on a diameter.

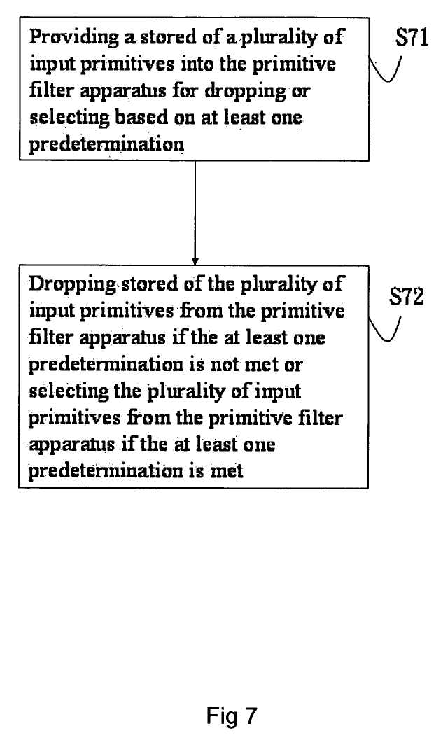

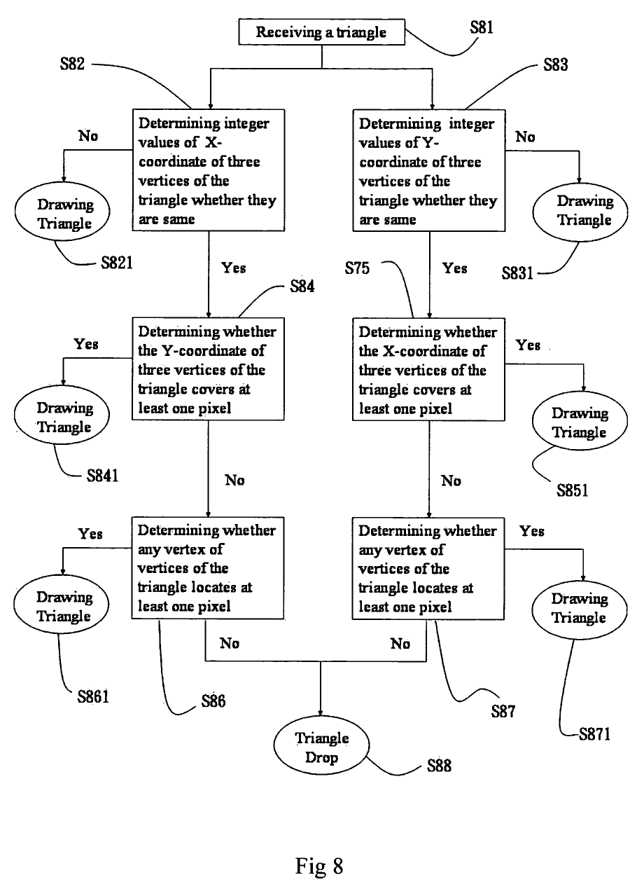

Referring to FIG. 7 and FIG. 8, two flowcharts of a primitive filtering method in a primitive filter apparatus are illustrated. As shown in FIG. 7, the method at least comprises: providing a stored of a plurality of input primitives into the primitive filter apparatus for dropping or selecting based on at least one predetermination as step 71 and dropping stored of the plurality of input primitives from the primitive filter apparatus if the at least one predetermination is not met or selecting the plurality of input primitives from the primitive filter apparatus if the at least one predetermination is met as step 72.

Referring to FIG. 8, a detail flowchart of a primitive filtering method is illustrated. The primitive filter apparatus implements filtering process. The method further comprises following steps (e.g. triangles are such a primitive): the primitive filter apparatus receives a triangle S81 for further determining. First, the primitive filter apparatus determines whether integer values of X-coordinate of three vertices of the triangle are same as step S82. If not, the triangle will be drawn as step S821. Meanwhile, the primitive filter apparatus also determines whether integer values of Y-coordinate of three vertices of the triangle are same S83. If not, the triangle will be drawn as step S831. If both determining results are yes, the triangle will be taken to next determining stage. Second, the primitive filter apparatus then determines whether the Y-coordinate of three vertices of the triangle that covers at least one pixel as step S84. If yes, the triangle will be drawn as step S841. Meanwhile, the primitive filter apparatus also determines whether the X-coordinate of three vertices of the triangle that covers at least one pixel as step S85. If yes, the triangle will be drawn as step S851. If both determining results are not, the triangle will be taken to final determining stage. The primitive filter apparatus determines whether any vertex of three vertices of the triangle locates at least one pixel as step S86. If yes, the triangle will be drawn as step S861. Meanwhile, the primitive filter apparatus determines whether any vertex of three vertices of the triangle locates at least one pixel as step S87. If yes, the triangle will be drawn as step S871. If both determining results are not, the triangle will be taken away as step S88. Entire filtering process in the primitive filter apparatus is accomplished through the above steps.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the description above, the present invention is novel and useful and definite enhances the performance over the conventional structure and further complies with the patent application requirements and is submitted to the Patent and Trademark Office for review and granting of the commensurate patent rights.

What is claimed is:

1. A primitive filter apparatus, comprising:
a storage unit for storing a plurality of input primitives; and
a filter unit, coupled to the storage unit, operative to process the stored of the plurality of input primitives, the filter unit including means for dropping or selecting the stored of the plurality of input primitives based on at least one predetermination.

2. The primitive filter apparatus of claim 1, wherein the primitive filter apparatus can be set between a vertex shader and a primitive setup unit.

3. The primitive filter apparatus of claim 1, wherein the primitive filter apparatus is applied in Graphic Process Unit.

4. The primitive filter apparatus of claim 1, further including an associated data for corresponding to the stored of the plurality of input primitives, wherein the associated data are primitive parameters, the primitive parameters can be one of the following: object shape data in object space, color, texture information, viewing angle information, and lighting information.

5. The primitive filter apparatus of claim 1, wherein the primitives can be a point, and the associated data for the point includes position and/or point size.

6. The primitive filter apparatus of claim 1, wherein the primitives can be a line, and the associated data for the line includes position of two end points, position of line center, length, and slope.

7. The primitive filter apparatus of claim 1, wherein the primitives can be a polygon, and the associated data for the polygon includes position of vertices.

8. The primitive filter apparatus of claim 1, wherein the primitives can be a circle, and the associated data for the circle includes position of center and radius and position of two end points on a diameter.

9. The primitive filter apparatus of claim 1, wherein the primitives can be a circular disk, and the associated data for the circular disk includes position of center and radius and position of two end points on a diameter.

10. The primitive filter apparatus of claim 1, wherein the filter unit comprises an arithmetic logic unit (ALU) and a determination unit.

11. The primitive filter apparatus of claim 10, wherein the ALU executes arithmetic and logic calculations.

12. The primitive filter apparatus of claim 10, wherein the determination unit performs determinations according to calculation results, and the calculation result are provided by the arithmetic logic unit.

13. The primitive filter apparatus of claim 1, wherein the storage unit further comprises a controller and a data buffer.

14. The primitive filter apparatus of claim 1, further including a selection circuit, wherein the selection circuit is to produce a discard signal, the discard signal is provided by the determination unit.

15. The primitive filter apparatus of claim 1, wherein the at least one predetermination is a condition, the condition is to drop the stored of the plurality of input primitives if does not cover any pixels.

16. The primitive filter apparatus of claim 15, wherein the pixel is an integer-value, and the integer-value corresponds to a pixel grid coordinate system.

17. A primitives filtering method in a primitive filter apparatus, at least comprising the steps of:
a. providing a stored of a plurality of input primitives into the primitive filter apparatus for dropping or selecting based on at least one predetermination; and
b. dropping the stored of the plurality of input primitives from the primitive filter apparatus if the at least one predetermination is not met or selecting the plurality of input primitives from the primitive filter apparatus if the at least one predetermination is met.

18. The method of claim 17, further including a first inspecting stage, wherein the first inspecting stage corresponds to the at least one predetermination, and the first inspecting stage is to determine whether integer-values of X-coordinate and Y-coordinate of input primitives parameters are same.

19. The method of claim 17, further including a second inspecting stage, wherein the second inspecting stage corresponds to the at least one predetermination, the second inspecting stage is to determine whether Y-coordinate and X-coordinate of input primitives cover pixels.
